(19) United States
(12) Patent Application Publication
(10) Pub. No.: US 2005/0186843 A1
(43) Pub. Date: Aug. 25, 2005

(54) HDMI connector

(76) Inventor: Wen-Hsien Tsai, Taipei Hsien (TW)

Correspondence Address: JOHNSON & ASSOCIATES P.C., #282, 14625 BALTIMORE AVE, LAUREL, MD, 20707, US

(21) Appl. No.: 10/781,667

(22) Filed: Feb. 20, 2004

(51) Int. Cl. H01R 13/648

(52) U.S. Cl. 439/607

(57) ABSTRACT

The present invention provides a high definition multimedia interface (HDMI) connector with various types through combinations of the outer metallic shells and the inner terminal modules of the HDMI connector. The outer metallic shell may exhibit various types including with or without the presence of flange on the front edge of said outer metallic shell and with or without the application of the surface mount technology (SMT) to the solder pins. Therefore, the HDMI of the present invention is applicable to provide different types of connector to fulfill market requirements through the combinations of different types of module.

### BACKGROUND OF THE INVENTION

1. Field of the Invention

The present invention relates to a HIGH DEFINITION MULTIMEDIA INTERFACE (HDMI) connector, and more specifically to a small connector utilized in digital TV, DVD player, deck-top box (video signal converter), and other digital Audio/Video (AV) product.

2. Description of the Related Art

LCD in nowadays has become a most popular output device for Audio/Video (AV) product. Since it plays an important role in the products of modern PC monitor and TV display, and in the light of connector for digital signal transmission has become a mainstream product in LCD industries, the HDMI connector of the invention is thus created to serve this purpose.

The HDMI (High Definition Multimedia Interface) is a transmission interface utilized for the transmission of a high definition multimedia digital signal including high fidelity image and multi-channel audio signal. The earliest specification of the HDMI was established by several Audio/Video industries, such as HITACHI, Panasonic, Philips, Sony, Silicon Image, Thomson and Toshiba. It established the most frequently used standard specification based on DVI (Digital Visual Interface) for digital image signal transmission. The object of the invention is to transmit a digital screen signal between PC and LCD and display a live scene on LCD with high fidelity. Furthermore, the digital image signal transmitted by DVI also provides the effect of unauthorized copy proof, and its signal may be encoded at the transmitting end and decoded at receiving end that will provide the effect of preventing unauthorized reproduction of the image signal being transmitted. Although DVI improved the resolution and quality of picture on a LCD screen, however, DVI is not absolutely perfect, because it didn take the transmission of digital audio signal into account so far, therefore users need to connect additional line or use traditional AV terminal for signal transmission. This may not raise the question of compatibility among the signal transmissions in the application of personal computer, but it does cause chaos when used in the family theater set which is getting more and more popular among the consumers. Furthermore, as the digital products such as digital video camera and digital electronic camera are prevailed, it may become bothersome that if LCD TV requires a plurality connection lines. This may also increase the number of installation components for family theater set, and further increase the price of product. Therefore, the HDMI of the present invention is thus created for family theater set to eliminate the flaws of DVI mentioned above.

The HDMI of the present invention is not only in compliance with the standard specification of DVI but also take digital audio signal into account in the design of HDMI connector, which is not only fully compatible with DVI but also capable of transmitting uncompressed data of digital AV signal without distortion. Furthermore, the HDMI also has advantages, such as, it complies with all kinds of video format specification used in the market, thus, it is capable of communicating with all kinds of product by all kinds of video transmission formats. Therefore, the HDMI provides the best quality and high fidelity video signal for consumer AV products, and because it supports all kinds of transmission format of digital video signal, resulted in less cable and smaller connector for the transmission of uncompressed data. Furthermore, the HDMI also succeeded the feature of unauthorized copy proof of DVI. It will alleviate the burden of movie filmmakers worrying that the export of the highest quality video products will come across with unauthorized reproduction by piracy. The HDMI connector also provides two-way communication for digital TV, DVD player, deck top box (signal converter) and other small connectors of digital AV products. The advantage is that the player provides the best image quality through determining which format is suitable for the received signal automatically. The HDMI connector is more convenient to install inside different AV products, because it is designed to reduce the volume of interface connector significantly.

It is known from the mentioned above that the HDMI will be a mainstream connector for AV product in the future. The HDMI will be the first AV standard specification supported throughout the software supplier and system provider to CE (Consumer Electronics) makers in a chain link. Therefore, the HDMI connector needs to be built with a strong construction to comply with the demand of high speed transmission. The object of the invention is to provide such new type of connector construction for the newly developed system.

The metallic housing of current general connector has several connection types to adapt the structure of the PCB (printed circuit board). The metallic housing has two major types an insertion type and a SMT (surface mount technology) type. The connectors are usually mounted at the edge of printed circuit board to adapt the requirements of the housing structure of product and provide interface function for the connection of external and internal circuit of the product. Current connector has a flange with screw holes for engagement with the housing by screws to reinforce the fixity of connection. Furthermore, current contact terminal units also utilize the insertion type and the SMT type, and produce various types of connector through combination of accessories. However, miscellaneous types of connector will cause a great confusion in the procurement of accessories due to lack of interchangeability of the accessories, and thus increase the cost of accessory stock.

### SUMMARY OF THE INVENTION

The main object of the present invention is to provide a connector for high definition multimedia digital transmission interface which utilizes modular components in compliance with standard specification to assemble various types of connectors through combination of various modular components, therefore, minimize the number of components stock and thus reduce the cost of material.

Another object of the present invention is to provide a connector for high definition multimedia digital transmission interface, which utilizes an uniform insulated housing to combine with the different metallic housing and the contact terminal assemblies to establish a standard and swift assembly works.

To achieve the above objects, the HDMI connector in accordance with the present invention comprises an insulated housing, a metallic housing, and a contact terminal unit, characterized in that the insulated housing is an uniform standard design, whereas the metallic housing and the contact terminal unit are modular design. The structure of the metallic housing utilizes a standard design, and the solder pin and flange utilize modular design, wherein the solder pin is categorized in the vertical insertion type and the horizontal SMT type, and the flange is an optional selection according to the requirements of the products. The interior design of the metallic housing adapted to the engagement with the insulated housing utilizes the standard design, whereas the contact terminal unit is categorized in the vertical insertion type and the horizontal SMT type.

The present invention will be readily apparent to those skilled in the art upon reading the following description of a preferred embodiment of the present invention and upon reference to the accompanying drawings.

### DETAILED DESCRIPTION OF THE PREFERRED EMBODIMENTS

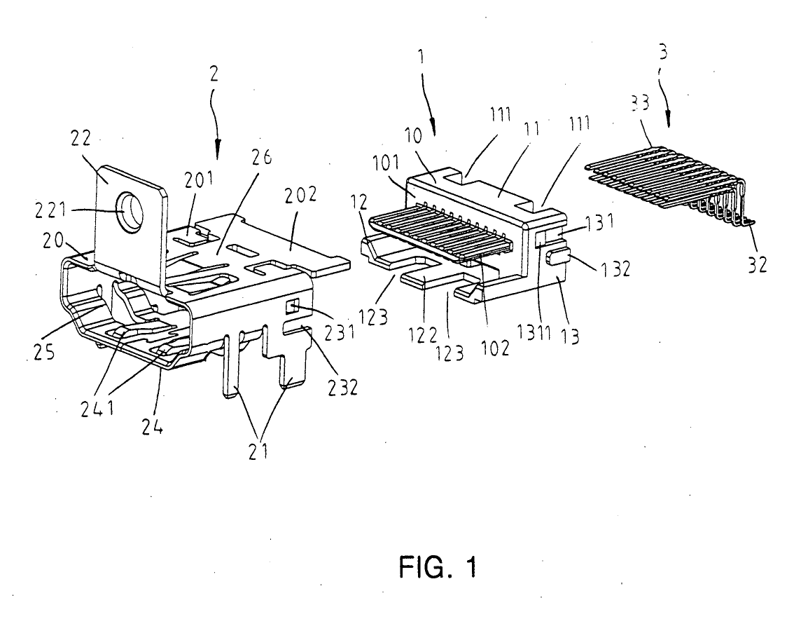

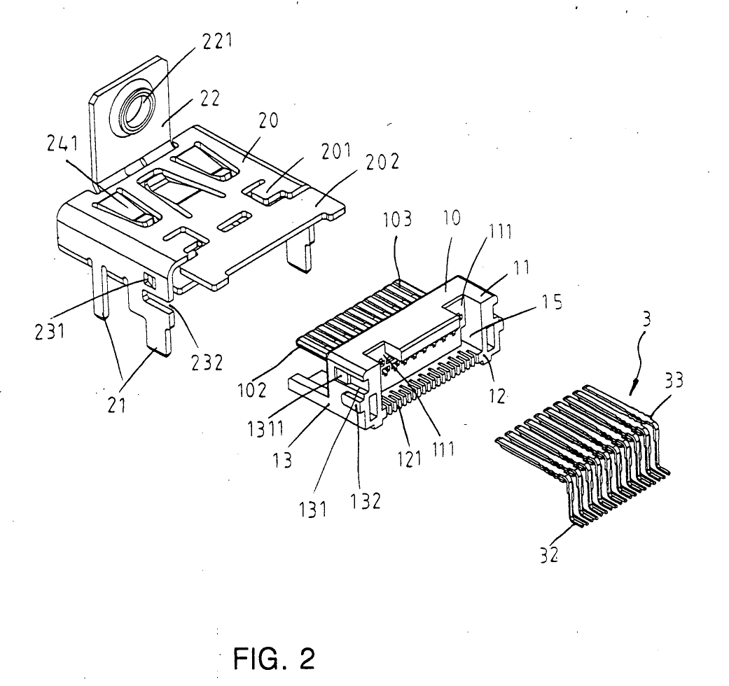

With reference to FIG. 1 and FIG.2, A HDMI connector of the present invention comprises an insulated housing 1, a metallic housing 2, and a contact terminal unit 3, wherein the insulating housing 1 is an standard design, whereas the metallic housing 2 and the contact terminal unit 3 are modular design. The structure of the metallic housing 2 utilizes an standard design, and the solder pin 21 and flange 22 utilize modular design, wherein the solder pin 21 is categorized in the vertical insertion type 211 and the horizontal SMT type 212, and the flange 22 is an optional selection according to the requirements of the products. The interior design of the metallic housing 2 adapted to the engagement with the insulated housing 1 utilizes the standard design, whereas the solder pin of the contact terminal unit 3 is categorized in the vertical insertion type 31 and the horizontal SMT type 32.

Because the embodiments of the invention present various types utilizing a combination of different module types, for purpose of convenient explanation the inventor designates the metallic housing 2 with flange 22 as and without flange 22 as and the metallic housing 2 with the solder pin 21 utilizes the vertical insertion type 211 is designated as and the horizontal SMT type 212 as and the contact terminal unit 3 with the solder pin 21 utilizes the vertical insertion type 211 of is designated as and the horizontal SMT type 212 as.

The embodiment of ABC type connector structure will be described hereinafter. Referring to FIG. 1 and FIG. 2, the insulated housing 1 has a rectangular main block 10, and a flat terminal block 102 is projected from the front surface 101 of the main block 10, there is a plurality of guide slots 103 furnished on the top and bottom side of the terminal block 102 for insertion of the terminal of contact terminal unit 3, and the guide slots 103 is fed through the main body 10 to the hollow portion 15 at the rear part of the main body 10. When the insulated housing 1 is inserted into the metallic housing 2, the front surface 101 may thrust against the rear end of insertion slot at the bottom of the metallic housing 2 and retain the metallic housing 2 in place. The dented slots 111 are furnished at the two sides of the top surface 11 of the main body 10 hollowed at rear part; the function of the slots 111 is to latch with the resilient fold piece 201 on the top surface 26 to secure the fixity of the insulated housing 10 when moved into the metallic housing 2. The slot 131 and the projection 132 are furnished on the both side surfaces 13 of the main body 10 whereby the slots 131 are mated with the inward projected stop wedge 231 of the metallic housing 2, and the stop block 1311 is furnished at the end of the inner slots 131 may thrust with the stop wedge 231 to secure the insulated housing 1 inside the metallic housing 2 without further backward displacement, and the projection 132 mated with the slide slot 232 of the metallic housing 2 to secure the insulated housing 1 inside the metallic housing 2 without further forward displacement. The positioning paths 121 dented inward at rear part of the bottom surface 12 of the main body 10 provide an equal number of guide slots 103 for insertion of the terminals of the terminal block 102 to secure the solder pin at the insertion spot. And the bottom plate 122 extended from the front end of bottom surface 12 of the main body 10 with inclined end section of both sidewalls form a carrier to be integrated with the bottom surface 24 of the metallic housing 2 and firmly fixed with each other. The recess 123 furnished on the bottom plate 122 with position aligned with the clamp 241 on the bottom surface 24 of the metallic housing 2 to keep the clamp 241 remained available after the integration with the insulated housing 1, furthermore, the positioning posts are also provided at the bottom of the insulated housing 1 to secure the connector firmly positioned on the printed circuit board.

The interior structure design complies with the uniform standard adopted by the insulated housing 1. The insertion opening 25 in the front end of the metallic housing 2 is furnished with error proof on both sides, this standard specification known in the industry will not be described herein. A feature of the invention is the integration structure of the insulated housing 1 and the rear part of the metallic housing 2. The integration consists of the fold piece on the top surface 26, the fold plate 202 extended to rear end, the inward projected stop wedge 231, and the slide slot 232, wherein the fold piece 201, the inward projected stop wedge 231 and the slide slot 232 are interacted with the corresponding integration structure of the insulated housing 1 when inserted in the metallic housing 2, wherein the fold piece 201, the inward projected stop wedge 231 and the slide slot 232 are mated with the slot 111, notch 131 and protrusion 132 respectively. Furthermore, the fold plate 202 is foldable to accommodate the whole insulated housing 1 inside the metallic housing 2 when the insulated housing 1 is inserted in, and there is a plurality of clamps 241 furnished on the top and bottom surfaces of the metallic housing 2 to latch the plug connector accordingly.

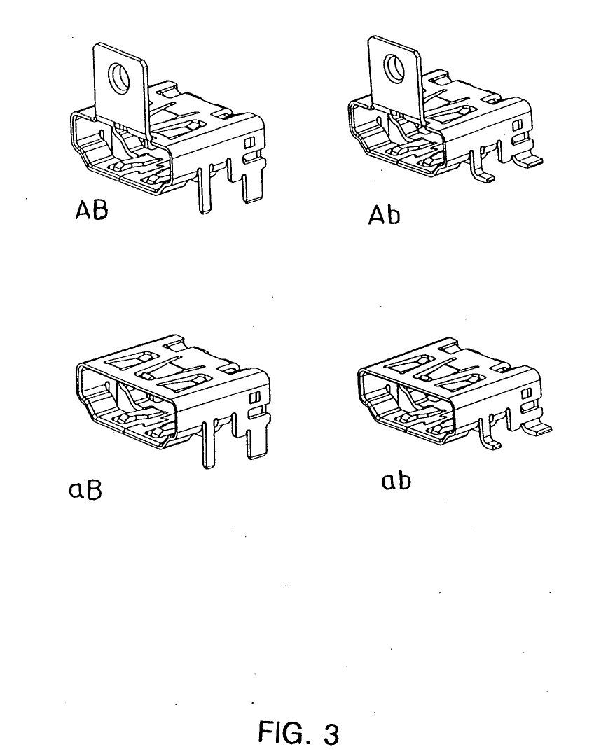

From the above description, it is understood that the metallic housing 2 and the insulated housing 1 of the HDMI connector of the present invention are thus fabricated and assembled through a multiple locking mechanism to form a rigid and compact structure in compliance with the strict requirements of high definition multimedia interface device. The specification of fold piece 201, fold plate 202, inward projected stop wedge 231 and slide slot 232 are all standardized to form standard modules of the metallic housing 2. The other feature of the invention is the design of the solder pin 21 and the flange 22, wherein the flange 22 furnished with lock hole is foldable in an upward vertical direction to fulfill the requirements of the print circuit board and the housing structure. The invention utilizes a basic standard structure to incorporate with the variations of the solder pin 21 and flange 22 to form a standard mode of the metallic housing. There are four types of metallic housing 2 of the embodiment, AB type metallic housing module utilizes the flange 22 and the solder pin 21 with a vertical insertion type solder pin 211, also referring to FIG. 3, Ab type metallic housing module utilizes the flange 22 and the solder pin 21 with the horizontal SMT type solder pin 211, aB type metallic housing utilizes without the flange 22 and the solder pin 21 with a vertical SMT type solder pin 212, and ab type metallic housing utilizes the flange 22 and the solder pin 21 with a vertical SMT type solder pin 212.

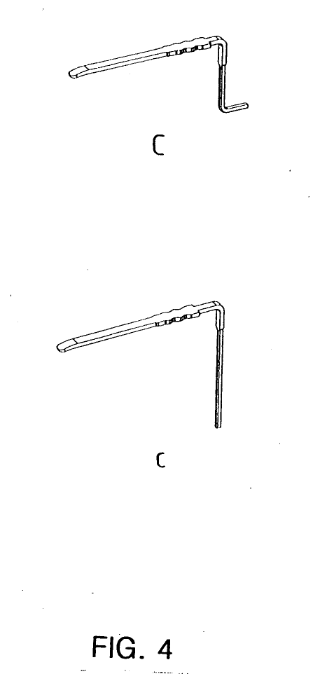

With reference to FIG. 1 and FIG. 2, the front end terminal contact portion of the contact terminal unit 3 of the embodiment 1 in FIG. 1 and FIG. 2 is of standard specification, and the spike 33 for fixing terminal is furnished at the rear end of the contact portion, wherein the rear end of the spike 33 is folded to form the solder pin, and the terminal solder pin in the embodiment is the horizontal SMT type terminal solder pin 32. There are two types of the contact terminal unit, one is the horizontal SMT type terminal solder pin 32 designated C type, and the other is the vertical insertion type terminal solder pin 31 designated c type (as shown in FIG.4).

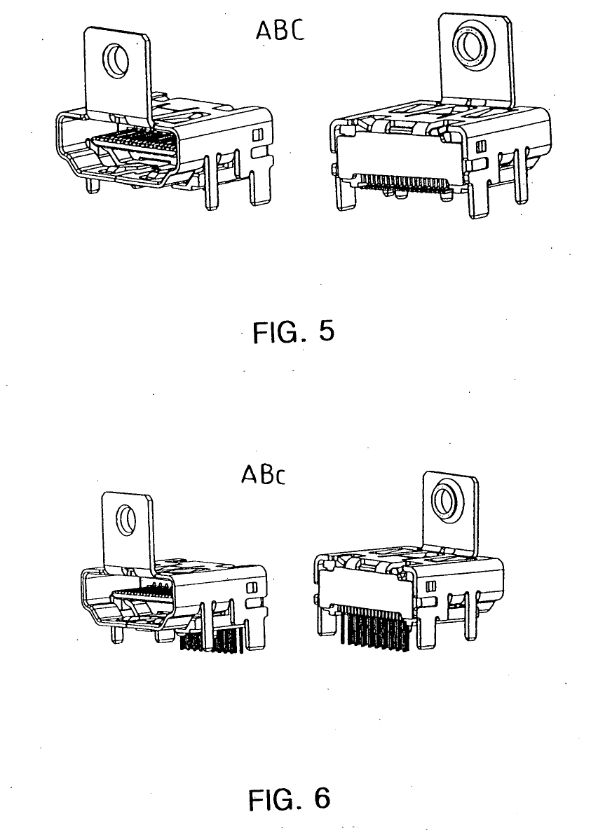

The assembly method of the invention is first to place the terminals of the contact terminal unit 3 into the guide slots 103 of the terminal block 102 of the insulated housing 1, followed by placing the terminal solder pin into the positioning path 121 on the bottom surface of the main body 10, and the front surface 101 of the insulated housing 1 will thrust against the rear end of the bottom insertion slot of the metallic housing 2 when the whole insulated housing 1 inserted in the metallic housing 2, wherein the notches 131 of the both side surfaces 13 being mated with the inward projected stop plate 231 of the metallic housing 2 thrust the stop block 1311 of the inner end of the notches 131 against the inward projected stop plate 231 to secure the insulated housing 1 in the inner part of the metallic housing 2 without further backward displacement. The projection 132 of the side surface 13 also cooperates with the slide slot 232 of the metallic housing 2 to secure the insulated housing 1 in the inner part of the metallic housing 2 without frontward displacement. Finally, the fold piece 201 on the top surface 20 of the metallic housing 2 is folded to mate with the slot 111 on the top surface 11 of the insulated housing I to reinforce the fixity of the insulated housing 1, and the fold plate 202 of the metallic housing 2 is folded to accommodate the insulated housing 1 into the metallic housing 2. As shown in the FIG. 5, a type of the invention presented by one of the module combinations designated as ABC type connector, wherein the solder pin 21 utilizes the vertical insertion type solder pin 211, the terminal utilizes the horizontal SMT type terminal solder pin 32 and with the flange 22 on the metallic housing 2.

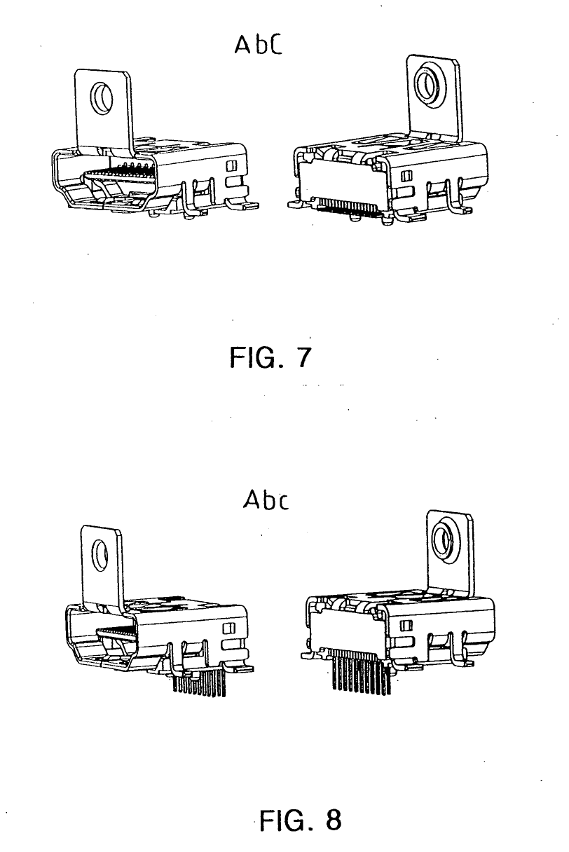

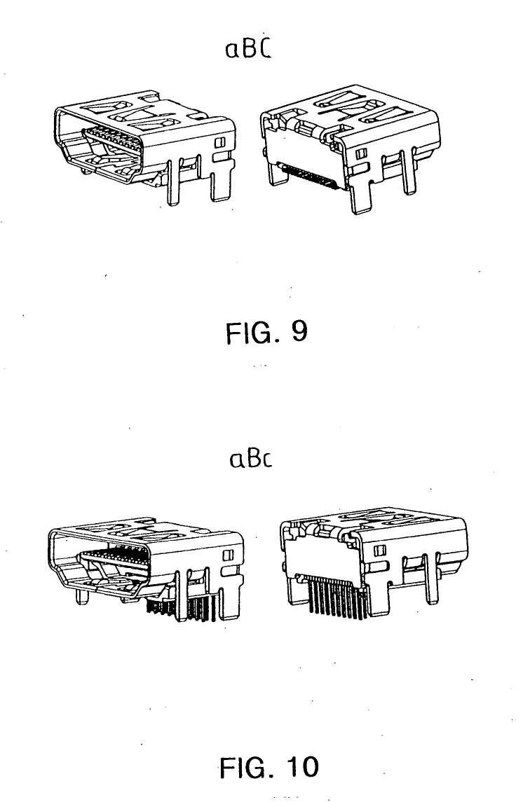

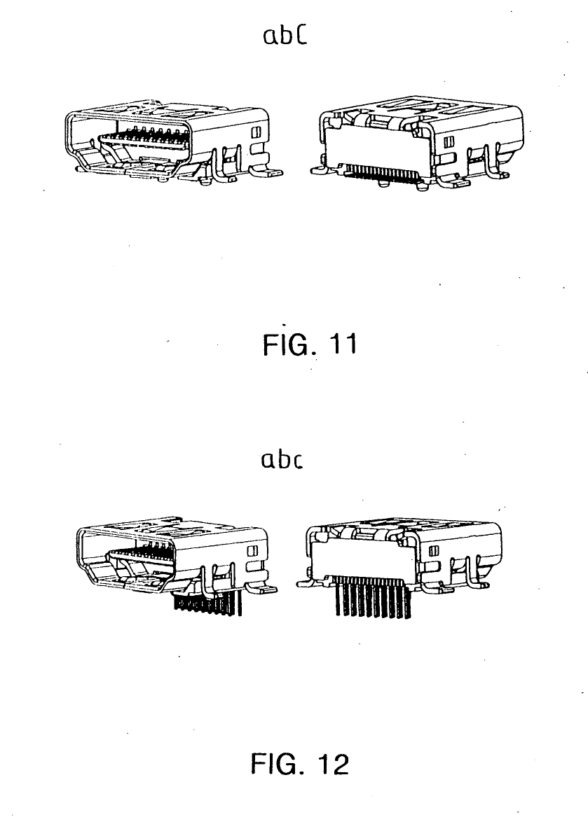

There is plurality of module types adopted for the invention. In FIG. 6, the embodiment No. 2 is an ABc type, which is composed of the solder pin 21 utilizing the vertical insertion type solder pin 211, the vertical insertion type terminal solder pin 31 and the flange 22 on the metallic housing 2. Referring to FIG. 7, the embodiment No. 3 is an AbC type which is composed of the solder pin 21 utilizing the horizontal SMT type solder pin 212, the horizontal SMT type terminal solder pin 32 and the flange 22 on the metallic housing 2. In FIG. 8, the embodiment No. 4 is an Abc type, which is composed of the solder pin 21 utilizing the horizontal SMT type solder pin 212, the vertical insertion type terminal solder pin 31 and the flange 22 on the metallic housing 2. In FIG. 9, the embodiment No. 5 is an aBC type which is composed of the solder pin 21 utilizing the horizontal SMT type solder pin 212, the horizontal SMT type terminal solder pin 32 and without the flange 22 on the metallic housing 2. In FIG. 10, the embodiment No. 6 is an aBc type which is composed of the solder pin 21 utilizing the horizontal SMT type solder pin 212, the vertical insertion type terminal solder pin 31 and without the flange 22 on the metallic housing 2. In FIG. 11, the embodiment No. 7 is an abC type which is composed of the solder pin 21 utilizing the horizontal SMT type solder pin 212, the horizontal SMT type terminal solder pin 32 and without the flange 22 on the metallic housing 2. In FIG. 12, the embodiment No. 8 is an abc type which is composed of the solder pin 21 utilizing the horizontal SMT type solder pin 212, the vertical insertion type terminal solder pin 31 and without the flange 22 on the metallic housing 2.

From the above description it is understood that the HDMI connector in accordance with the present invention utilizes modular design to standardize the specification of the connectors. It provides four types of the metallic housing 2 and two types of the contact terminal unit 3 to compose eight types of the HDMI connector providing more flexibility and swiftness in assembly, and also simplifies material stocks and promotes mobility of the product variation in the assembly line.

Although the present invention has been described with reference to a preferred embodiment thereof, it is apparent to those skilled in the art that there are a variety of modifications and changes that may be made without departing from the scope of the present invention which is intended to be defined by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A HDMI connector comprising: a contact terminal unit, wherein in the contact terminal unit further comprises vertical insertion types and horizontal SMT types; an insulated housing, wherein the insulated housing further comprises a rectangular main block, a flat terminal block projected from the front surface of the main block, a plurality of guide slots furnished on the top and bottom side of the terminal block for inserting a terminal portion of the contact terminal unit, and the guide slots are fed through a hollow portion of a main body's rear end portion; a metallic housing adapted for engaging said insulated housing; a flange and a solder pin wherein said solder pin further comprises vertical insertion types and horizontal SMT types.

21. The HMDI connector according to claim 20, wherein dented slots are furnished at two sides of the main body's top surface, and said dented slots are used to latch with a resilient fold piece on the main body's top surface.

22. The HDMI connector according to claim 20, wherein slots and projections are furnished on both side surfaces of the main body, the slots are mated with an inward projected stop wedge of the metallic housing, and a stop block furnished at the end of inner located slots, which thrust with the stop wedge to secure the insulated housing inside the metallic housing without further backward displacement.

23. The HDMI connector according to claim 20, wherein positioning paths dented inward at rear portions of the main body's bottom surface provide an equal number of guide slots for inserting terminals of the terminal block.

24. The HDMI connector according to claim 20, wherein a bottom plate extends from front ends of the main body's bottom surface and inclined end sections of both side walls of the main body form a carrier used for integrating with the bottom surface of the metallic housing and thus firmly fixing with each other.

25. The HDMI connector according to claim 20, wherein a recess furnished on the bottom plate is positioned and aligns with a clamp on the bottom surface of the metallic housing, the clamp remains available after integrating with the insulated housing, and positioning posts are also provided at the bottom of the insulated housing to secure and position the connector firmly on the printed circuit board.

26. The HDMI connector according to claim 20, wherein a perfectly formed insertion opening located at the metallic housing's front end is furnished on both sides.

27. The HDMI connector according to claim 26, wherein the insulated housing's integration structure and the metallic housing's rear portion further comprises a fold piece located on the top surface of the connector, a fold plate extended to the rear end of the connector, an inward projected stop wedge and a slide slot.

28. The HDMI connector according to claim 27, wherein the fold piece is mated with the insulated housing's slot.

29. The HDMI connector according to claim 27, wherein the inward projected stop wedge is mated with a notch.

30. The HDMI connector according to claim 27, wherein the slide slot is mated with a protrusion.

31. The HDMI connector according to claim 27, wherein the fold plate is foldable to accommodate the entire insulated housing inside the metallic housing when the insulated housing is inserted therein.

32. The HDMI connector according to claim 20, wherein the flange is furnished with lock hole.

33. The HDMI connector according to claim 20, wherein the metallic housing utilizes the flange and the solder pin having a vertical, insertion type structure.

34. The HDMI connector according to claim 20, wherein the metallic housing utilizes the flange and the solder pin having a horizontal, SMT type structure.

35. The HDMI connector according to claim 20, wherein the metallic housing is without the flange and utilizes the solder pin having a vertical, insertion type structure.

36. The HDMI connector according to claim 20, wherein the metallic housing is without the flange and utilizes the solder pin having a horizontal, SMT type structure.

37. The HDMI connector according to claim 20, wherein the contact terminal unit utilizes the solder pin having a horizontal, SMT type structure.

38. The HDMI connector according to claim 20, wherein the contact terminal unit utilizes the solder pin having a vertical, insertion type structure.
